(19) United States
(12) Patent Application Publication
(10) Pub. No.: US 2004/0059926 A1
(43) Pub. Date: Mar. 25, 2004

(54) Network interface controller with firmware enabled licensing features

(75) Inventors: Michael F. Angelo, Houston, TX (US); B. Tod Cox, Houston, TX (US); David L. Kasperson, Round Rock, TX (US)

Correspondence Address: CONLEY ROSE, P.C., P. O. BOX 3267, HOUSTON, TX, 77253-3267, US

(73) Assignee: Compaq Information Technology Group, L.P., Houston, TX

(21) Appl. No.: 10/251,927

(22) Filed: Sep. 20, 2002

(51) Int. Cl. H04L 9/00

(52) U.S. Cl. 713/189; 713/181; 713/176

(57) ABSTRACT

An electronic device has a plurality of selectable capabilities. The capabilities may include CPU speed, NIC speed, various protocols, or, in general, any parameters, characteristics or features which a user might desire to have in the electronic device. The device receives a key, such as from an external licensing authority, and the key specifies which capabilities the device should use to configure itself. The user may have to pay the licensing authority for the key. The electronic device thus can be configured into any one of a plurality of capabilities without having to change any hardware—the user simply purchases a key commensurate with a capability desired by the user.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to dynamic license control of functionality and features in an electronic (e.g., computer or computer-related device). More particularly, the invention relates to a method and apparatus which enable various capabilities in a network interface card (“NIC”) for a period of time.

2. Background of the Invention

Computers and other types of electronic devices are available with a wide variety of capabilities. In general, higher performance computers cost more than lower performance computers. Thus, purchasers and users of computers are faced with having to trade off price against performance when purchasing a computer and peripheral devices.

Recognizing that many computer purchasers demand higher performance computers and are willing to pay a price premium for such performance while other purchasers are satisfied with lower performance computers and thus demand lower prices, computer manufacturers provide a variety of models with varying levels of performance and corresponding prices. This business model is generally satisfactory to the consumer, but places a considerable burden on the manufacturer who must manage the manufacture of numerous different computer models, track different parts for different models, track inventory of individual models, etc. Additionally, a user who purchases one model today, may subsequently desire different capabilities in the device and thus may be forced to scrap the old device in favor of a new one with the desired capabilities. Moreover, purchasers prefer to have choices.

Accordingly, from the manufacturer's perspective, it would be best to produce just one physical model. Customers, however, prefer choices. A solution is needed that melds together these two competing concerns.

### BRIEF SUMMARY OF THE INVENTION

The problems noted above are solved in large part by an electronic device that has a plurality of selectable capabilities that can be used to configure the device. The capabilities may include CPU speed, NIC speed, various protocols, or, in general, any parameters, characteristics or features which a user might desire to have in the electronic device. The device receives a key, such as from an external licensing authority, and the key specifies which configuration capability/capabilities the device can use. The user may have to pay the licensing authority for a key to obtain functionality in accordance with agreed upon terms. The electronic device thus can be configured into any one of a plurality of capabilities without having to buy a new device altogether or even change any hardware in the existing device—the user simply purchases a key commensurate with a capability desired by the user.

In accordance with one of a plurality of preferred embodiments of the invention, the electronic device comprises a computer system that includes a first CPU, memory coupled to the first CPU, and a network interface card (“NIC”) coupled to the first CPU. Further, the NIC may include a second CPU and non-volatile memory coupled to the second CPU and contain a plurality of selectable capabilities. The NIC is adapted to be coupled to a network link and is configured to receive a key via the network link. The key preferably is operative to select a capability from the plurality of selectable capabilities.

If desired, the key can be secured to prevent theft and electronic tampering with the key. To that end, the key may be encrypted, contain a hash value, or have other security features. Preferably, the key includes an identifier unique to the electronic device. The Identifier may be a MAC address, serial number, or other unique identifier associated with the device.

### BRIEF DESCRIPTION OF THE DRAWINGS

For a detailed description of the preferred embodiments of the invention, reference will now be made to the accompanying drawings in which:

FIG. 1 shows an electronic device in accordance with a preferred embodiment of the invention that has a plurality of selectable capabilities which can be selected based on an externally provided key;

FIG. 2 shows a computer system implementation of the preferred embodiment;

FIG. 3 shows a preferred embodiment in which a hash function is used to secure the key;

FIG. 4 shows a preferred embodiment in which the key is encrypted; and

FIG. 5 shows an alternative embodiment for securing the key.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. A network interface card (“NIC”) comprises a device that enables an interface between an electronic device such as a computer and a network link. The NIC may be implemented on a printed circuit card or be a single, or coupled set, of semiconductor devices (“chips”). To the extent that any term is not specially defined in this specification, the intent is that the term is to be given its plain and ordinary meaning.

### DETAILED DESCRIPTION OF THE PREFERRED EMBODIMENTS

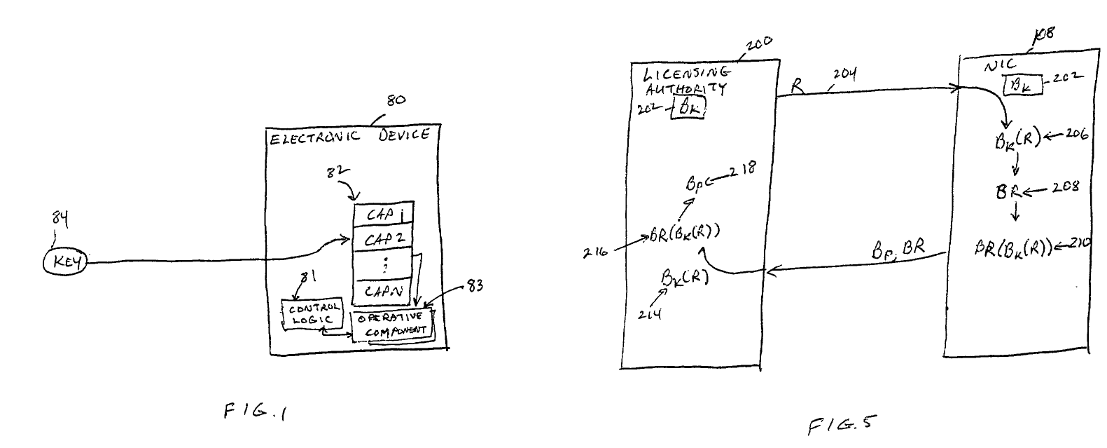

Referring now to FIG. 1, an electronic device 80 provides a plurality of individually selectable capabilities 82 (CAP1, CAP2, . . . CAPn) usable to configure device 80. The electronic device 80 also includes control logic 81 and one or more operative components which perform functions under control of the control logic 81 pursuant to the capability 82 that has been selected. The electronic device 80 may be a computer system, a computer peripheral device (e.g., a network attached storage device), or any other type of electronic device. The capabilities 82 may be central processing unit (“CPU”) speed, number of CPU slots activated for use, network interface card (“NIC”) speed, NIC protocol, or in general, any capability, function or characteristic that a user may desire for the device 80. The capabilities include those aspects that a purchaser would have considered when deciding whether to buy one model of an electronic device over another in accordance with conventional device manufacturing and purchasing behavior.

In accordance with the preferred embodiment, a single model of the electronic device 80 is provided which includes some or all of the various capabilities 82 that previously would have forced a manufacturer to provide different models. One or more of the capabilities 82 preferably are selectable by a “key” 84 and is provided in any form consistent with the teachings of this disclosure. The key 84 contains information which corresponds to one or more of the capabilities 82. By providing a suitable key to the electronic device 80, the electronic device can be configured to implement a desired capability commensurate with the key. As such, the electronic device 80 can be purchased for a base cost and with a base capability already implemented (e.g., a base CPU or NIC speed). Then, if the user wants to upgrade the electronic device 80 to have a higher capability, the user contacts a licensing authority, for example through the manufacturer's website, and for an additional predetermined price, purchases a key 84 corresponding to a new desired capability or capabilities. The newly purchased key 84 is then inserted or otherwise provided to the electronic device 80 which reads the key and implements the capability 84 identified by the key. Of course, if desired, the upgrade to a higher capability can be made upon the initial purchase of the electronic device. The key 84 may also encode time duration information. This information could cause the electronic device 80 to enable the desired capability for a period of time as specified by the duration information. Thus, if desired, the user can pay to upgrade the electronic device 80 for a limited period of time, at the end of which, the electronic device 80 may automatically revert back to its previous configuration. Higher prices may be charged for longer periods of time. Needless to say, charging a price for the new capability is not required—different capabilities can be provided for free.

In this manner, a manufacturer advantageously can make a single model of an electronic device with multiple capabilities and a purchaser or user can purchase whatever capability he or she desires. The key 84 can be purchased or otherwise obtained on-line or over the telephone from the licensing authority. Alternatively, the electronic device 80 itself can be made to generate the keys 84 thereby not requiring the user to interact with a third party to obtain the key. If money is required to obtain the key, the device 80 can automatically contact (e.g., on-line) a third party licensing authority on behalf of the user.

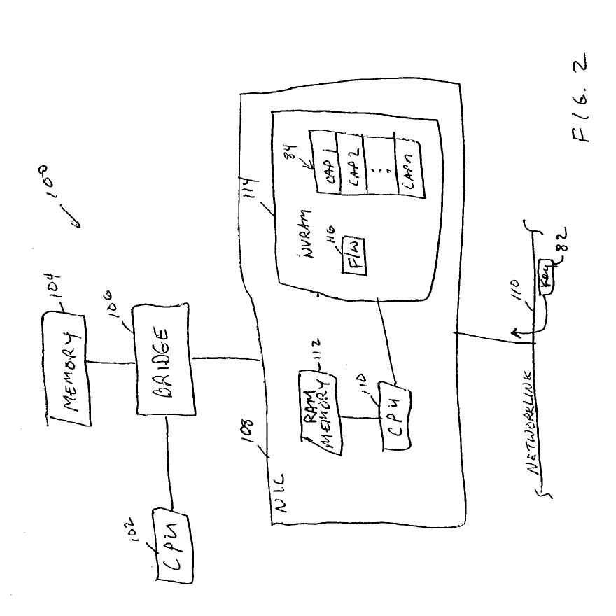

A variety of embodiments are possible and all are included within the scope of this disclosure. FIGS. 2-4 illustrate several of such embodiments. Referring first to FIG. 2, computer system 100 in accordance with a preferred embodiment comprises a CPU 102, memory 104 and a NIC 108 coupled together via a bridge device 106. One of ordinary skill in the art will appreciate that numerous other configurations are possible as well and other devices (e.g., keyboard, display, mouse, etc.) may be included. The NIC 108 preferably includes its own CPU 110 coupled to volatile random access memory (“RAM”) 112 and non-volatile RAM 114. Other components may be included as well. As shown, the NVRAM 114 preferably includes firmware 116 executable by CPU 110 and capabilities 84. The NIC capabilities 84 may include various speed levels (e.g., 100 megabits/second, 1 gigabit/second, etc.), various NIC protocols, or any other desired NIC-related feature or characteristic a user might desire. The NIC 108 couples the computer system 100 to a network link 110 which may comprise Ethernet or another suitable network topology.

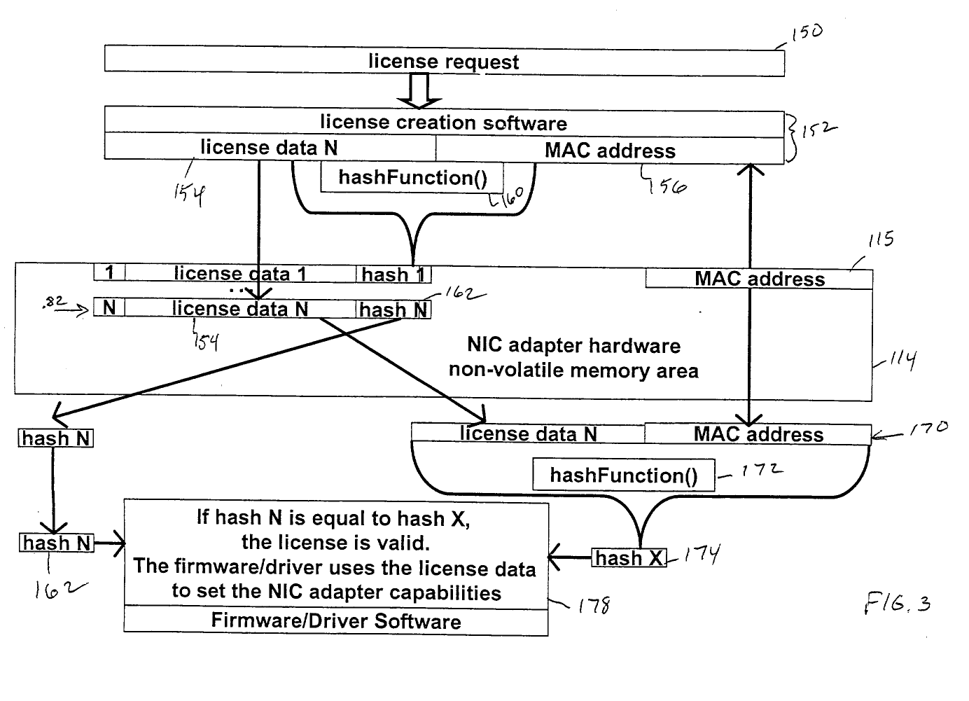

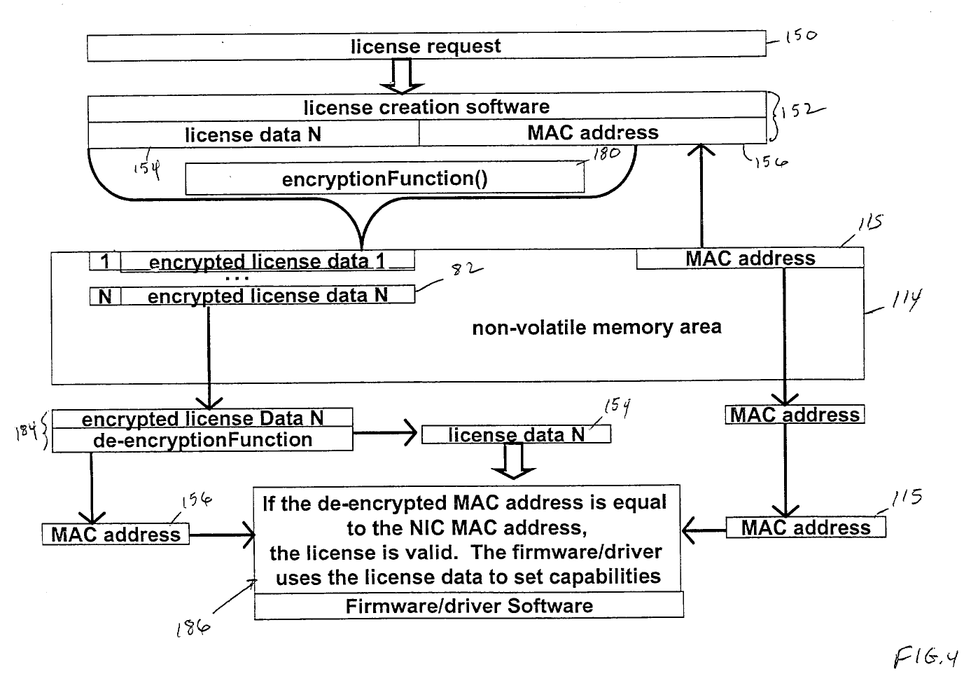

Referring still to FIG. 2, the key 82 is supplied from a licensing authority (not specifically shown) via the network link 110 to which the NIC 108 connects. The key preferably is implemented in a secured way that protects the key itself from theft and permits the computer system 100, and specifically the NIC 108, to verify the authenticity of the key. Numerous techniques for securing the key are possible. Two such techniques are discussed below with regard to FIGS. 3 and 4.

FIG. 3 shows a sequence flow that uses a “hash” function to secure the key. At 150, the user or owner of the computer system 100 submits a request to a licensing authority to change the capability of the NIC 108. This request can be made on-line via the Manufacturer's website, through another third party, and alternatively using a telephone or other mechanism to exchange key information.. As noted above, the request also can be internal to computer 100 which thereby generates the key itself. The request preferably includes a unique identifier associated with the NIC. In the example of FIG. 3, the unique identifier comprises the NIC's MAC address 115, which is a well known entity to those of ordinary skill in the art. Alternatively, the unique identifier could be a serial number associated with the NIC. The license request 150 may also include the specific capability(ies) that the user now desires and may contain other information such as the user's name, address, telephone number, email address, etc.

At 152, the licensing authority generates license data 154 to which the NIC's MAC address 156 is associated. The license data 154 preferably includes information which comprises or is otherwise indicative of the capability the user now desires. For example, the license data may include a new NIC speed or may include a value understood by the NIC's firmware 116 that is associated with the desired NIC speed. The license data may also include various levels of protocol support or other selectable capabilities of the NIC. The license data 154 is provided via network link 110 to the NIC's NVRAM 114. Steps 150 and 152 preferably are performed by software owned by the licensing authority.

In accordance with the preferred embodiment, the combination of the license data 154 and NIC MAC address 156 are run through a hash function 160 which produces a hash value 162 and also is implemented by the licensing authority's software. The hash function 160 preferably comprises any suitable hash function usable to verify the integrity of the key. The key 82 preferably comprises the license data 154 and associated hash value 162 and cryptographic coupling. As is commonly known, a hash function comprises a mathematical transformation that takes an input (e.g., the combination of the license data and MAC address) and returns a fixed-size hash value. When used in cryptography, hash functions preferably are “one-way” functions meaning that, given a hash value, it is very difficult (computationally infeasible) to have two different sets of inputs generate the exact same hash. Hash functions are well known in the art and their explicit structures are beyond the scope of this disclosure. However, reference can be made to one hash technology via http://csrc.nist.gov/encryption/shs/dfips-180-2.pdf_ incorporated herein by reference, for further descriptions of hash functions.

As noted above, the key 82 comprising the license data 154 and hash value 162 is stored in the NIC's NVRAM 114. When the computer system 100 and NIC 108 next initialize (or when the NIC detects the presence of the new key 82), the license data 154 and the NIC's MAC address are combined together at 170 and run through a hash function 172 which is the same function as hash function 160. The result of hash function 172 is hash value 174. The hash value 162 associated with the target license data 154 is also retrieved from the NMC's NVRAM 114. At 178, the retrieved hash value 162 (which was originally generated by the licensing authority) is compared to the newly generated hash value 174. If the two hash values match, the key is considered valid and the NIC capability will be altered in accordance with the verified new license data. If the two hash values do not match, the key is considered invalid and the capability of the NIC 108 will not be altered in accordance with the attempted new key. The retrieval of the license data 154 and hash value 162 from memory 114, computation of the new hash value at 172, comparison of the two hash values, verification of the key and alteration of the NIC's capabilities in accordance with a valid key preferably are performed by the NIC's CPU 110 running firmware 116.

FIG. 4 shows an alternative embodiment in which the license data and MAC address are encrypted rather than hashed. As before, a request is made at 150 to the licensing authority to change the capability of the NIC 108. At 152, the licensing authority combines the license data 154 and MAC address 156 together and then, at 180 encrypts that combination of values to produce an encrypted key 82. The encrypted key 82 is provided over the network link 110 to the computer's NIC 108 which preferably stores the encrypted key in NVRAM 114.

Then, upon the subsequent initialization of the NIC 108 (or when the NIC detects the presence of a new encrypted license key 182), the encrypted license key 182 is decrypted at 184 by the NIC's CPU with a decryption function corresponding to the encryption function used to encrypt the key in the first place, as would be known by those of ordinary skill in the art. The decryption process produces the underlying MAC address 156 and license data 154. The decrypted MAC address 156 is compared to the NIC's MAC address 115. If the two MAC addresses match, the key is considered valid and the NIC capability will be altered in accordance with the verified new license data. If the two MAC addresses do not match, the key is considered invalid and the capability of the NIC 108 will not be altered in accordance with the attempted new key.

FIG. 5 depicts another embodiment of the invention in which a pre-defined shared key Bk 202 is used. One copy of the shared key Bk is retained by the licensing authority 200 and the other copy by the NIC 108. In this embodiment, the licensing authority generates and, at 204, sends a random number R to the NIC 108. As depicted at 206, NIC 108 preferably uses its copy of the shared key Bk to encrypt the random number R. The NIC 108 also generates its own random number BR at 208 and then re-encrypts Bk(R) with the BR to produce BR(Bk(R)) at 210.

Any suitable fractional party of BR(Bk(R)) (designated as Bp) is generated (e.g., the lowest order 4 bits of BR(Bk(R)) and is transmitted to the licensing authority 200 along with the random number BR generated by NIC 108. The licensing authority then preferably encrypts the random number R it generated with its copy of Bk 202 (step 214). This value in turn is encrypted at 216 with BR provided by the NIC to produce BR(Bk(R)). At 218 the licensing authority 200 then obtains the same fractional part Bp of BR(Bk(R)). If the value Bp generated by the licensing authority matches Bp provided by the NIC, then the licensing authority preferably uses the value BR(Bk(R)) to digitally sign a key containing the licensing data. The NIC 108 would use this signed key to enable or disable capabilities as discussed previously.,

How the electronic device (or NIC) is altered to implement the new capability depends, of course, on the particular capability selected. If the capability involves speed (e.g., CPU speed, NIC speed), clock throttling and other known speed control techniques can be used. If the capability involves a particular protocol (e.g., NIC communication protocol), the various possible protocols can be stored in memory in the NIC in the form of tables or files and the file loaded for use commensurate with the key.

The preferred embodiments discussed above permit a single model of an electronic device to enable whichever capabilities a user chooses. This alleviates the burdens on the manufacturer associated with manufacturing multiple versions of the same device.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic device, comprising:
control logic; and
an operative component coupled to said control logic, said operative component implements a capability selected from a plurality of capabilities by an externally provided key.

2. The electronic device of claim 1 wherein said operative component comprises a network interface card (“NIC”) and said selected capability includes speed of said NIC.

3. The electronic device of claim 1 wherein said key includes an identifier value unique to said electronic device.

4. The electronic device of claim 3 wherein said key also includes a hash value comprising license data and said identifier value that have been processed by a hash function, said license data includes information indicative of said selected capability.

5. The electronic device of claim 1 wherein said key includes a hash value comprising license data that has been processed by a hash function, said license data includes information indicative of said selected capability.

6. The electronic device of claim 1 wherein said key comprises an encrypted value.

7. The electronic device of claim 6 wherein said encrypted value comprises license data containing information indicative of said selected capability, said license data being encrypted.

8. The electronic device of claim 6 wherein said encrypted value comprises license data and an identifier value associated with said electronic device that have been encrypted, said license data containing information indicative of said selected capability.

9. The electronic device of claim 6 wherein said key has been digitally signed.

10. The electronic device of claim 8 wherein said identifier value comprises a MAC address associated with said electronic device.

11. The electronic device of claim 8 wherein said identifier value comprises a serial number associated with said electronic device.

12. The electronic device of claim 1 wherein the key includes a time value indicative of a period of time during which the selected capability remains selected and at the expiration of which the electronic device changes to a different capability.

13. A computer system, comprising:
a first CPU;
memory coupled to said first CPU;
a network interface card (“NIC”) coupled to said first CPU and including a second CPU and non-volatile memory coupled to said second CPU and containing a plurality of selectable capabilities, said NIC adapted to be coupled to a network link;
wherein said NIC is configured to receive a key via said network link, said key is operative to select a capability from said plurality of selectable capabilities.

14. The computer system of claim 13 wherein said plurality of capabilities include one or more NIC speeds.

15. The computer system of claim 13 wherein said key includes an identifier value unique to said NIC.

16. The computer system of claim 15 wherein said key also includes a hash value comprising license data and said identifier value that have been processed by a hash function, said license data includes information indicative of said selected capability.

17. The computer system of claim 13 wherein said key includes a hash value comprising license data that has been processed by a hash function, said license data includes information indicative of said selected capability.

18. The computer system of claim 13 wherein said key comprises an encrypted value.

19. The computer system of claim 18 wherein said encrypted value comprises license data containing information indicative of said selected capability, said license data being encrypted.

20. The computer system of claim 18 wherein said encrypted value comprises license data and an identifier value associated with said NIC that have been encrypted, said license data containing information indicative of said selected capability.

21. The computer system of claim 20 wherein said identifier value comprises a MAC address associated with said NIC.

22. The computer system of claim 20 wherein said identifier value comprises a serial number associated with said NIC.

23. The electronic device of claim 13 wherein the key includes a time value indicative of a period of time during which the selected capability remains selected and at the expiration of which the computer system changes to a different capability.

24. A method of configuring an electronic device having a plurality of selectable capabilities, comprising:
(a) submitting a license request to a licensing authority;
(b) receiving a key from said licensing authority;
(c) selecting one or more of said selected capabilities based on said key; and
(d) configuring said electronic device based on said selectable capabilities.

25. The method of claim 24 wherein (a) includes submitting the license request electronically.

26. The method of claim 24 wherein the key is encrypted.

27. The method of claim 24 wherein the key comprises a value indicative of the capability to be selected and a hash of said value.

28. The method of claim 24 wherein the key comprises a value indicative of the capability to be selected and a hash of a combination of said value and an identifier unique to said electronic device.

29. The method of claim 28 wherein said identifier comprises a MAC address.

30. The method of claim 28 wherein said identifier comprises a serial number.

31. The method of claim 28 wherein said electronic device comprises a computer system.

32. The method of claim 28 wherein said electronic device comprises a network interface card (“NIC”).

33. A network interface card (“NIC”) adapted to be coupled to a network link, comprising:
a CPU; and
memory coupled to said CPU containing a plurality of selectable capabilities;
wherein said NIC is configured to receive a key via said network link, said key operative to select a capability from said plurality of selectable capabilities.

34. The NIC of claim 33 wherein said plurality of selectable capabilities include one or more NIC speeds.

35. The NIC of claim 33 wherein said key includes an identifier value unique to said NIC.

36. The NIC of claim 35 wherein said key also includes a hash value comprising license data and said identifier value that have been processed by a hash function, said license data includes information indicative of said selected capability.

37. The NIC of claim 33 wherein said key includes a hash value comprising license data that has been processed by a hash function, said license data includes information indicative of said selected capability.

38. The NIC of claim 33 wherein said key comprises an encrypted value.

39. The NIC of claim 38 wherein said encrypted value comprises license data containing information indicative of said selected capability, said license data being encrypted.

40. The NIC of claim 38 wherein said encrypted value comprises license data and an identifier value associated with said NIC that have been encrypted, said license data containing information indicative of said selected capability.

41. The NIC of claim 40 wherein said identifier value comprises a MAC address associated with said NIC.

42. The NIC of claim 40 wherein said identifier value comprises a serial number associated with said NIC.
